(19) United States
(12) Patent Application Publication
(10) Pub. No.: US 2020/0196113 A1
(43) Pub. Date: Jun. 18, 2020

(54) Boosting Web Contents

(71) Applicant: RUCHUP INC., New Castle, DE (US)

(72) Inventor: Michael Jehuda DESFORGES, Tel Aviv (IL)

(21) Appl. No.: 16/628,709

(22) PCT Filed: Dec. 6, 2017
(86) PCT No.: PCT/IL2017/051323

§ 371 Date: Jan. 6, 2020

Related U.S. Application Data
(60) Provisional application No. 62/455,610, filed on Feb. 7, 2017.

(51) Int. Cl. H04W 4/14; H04L 12/58; H04L 29/08; G06Q 50/00

(52) U.S. Cl. CPC H04W 4/14; H04L 51/32; H04L 51/12; G06Q 50/01; H04L 51/18; H04L 67/306; H04L 51/22

(57) ABSTRACT

A method and system including: receiving, by a message center, a message from an access device connected to a wireless network and associated with a first user, the message including content data representative of a content instance and a message data; storing, by the message center, the message content; calculating an impression volume based on the message data; selectively generating a distribution list based on the message data as related to the first user; distributing, by the message center, the message content to a number of members of the distribution list corresponding to the impression volume.

### FIELD OF THE INVENTION

The present invention relates to a web-based social media network tool and, more particularly, to a method and system for causing media contents to be viewed on the Internet-based social media tool, according to personal preferences.

### BACKGROUND OF THE INVENTION

Social media networks are generally free services accessible via a web-based user interface and/or a dedicated software application installed on a portable or mobile device (hereafter ‘mobile app’). To support the infrastructure and running costs of the networks, the administrators usually provide additional services for a fee. However, the main sources of income for these networks are advertisements that are displayed on the web interface (banners, panels etc.) as well as integrated advertisements that use the features of the networks to promote merchandise.

### SUMMARY OF THE INVENTION

According to the present invention there is provided a method including: receiving, by a message center, a message from an access device connected to a wireless network and associated with a first user, the message including content data representative of a content instance and a message data; storing, by the message center, the message content; calculating an impression volume based on the message data; selectively generating a distribution list based on the message data as related to the first user; distributing, by the message center, the message content to a number of members of the distribution list corresponding to the impression volume.

According to further features in preferred embodiments of the invention described below the message data includes a booster code, the booster code increasing the impression volume by a predefined number of units.

According to still further features in the described preferred embodiments the message data includes a filter, the filter providing rules for selecting the distribution list from members of the message center. According to still further features the filter indicates at least a portion of a sub network associated with the first user.

According to still further features the filter indicates one gender, or rules pertaining to a geographic location associate with the first user, or rules extracted from a profile of the first user.

According to still further features the message content is received by a second user and wherein the second user sends a booster code to the message center, resulting in the message center increasing the impression volume and distributing the message contents to corresponding number of additional members of the message center.

According to still further features the booster code includes data indicative of a graphical representation of an emotion, the graphical representation being displayed in association with the message content.

According to another embodiment there is provided a system including: one or more processors; and a memory coupled to the processors comprising instructions executable by the processors, the processors being operable when executing the instructions to: store data representative of a message content, the message content being associated with a first user; calculate an impression volume based on message data associated with the message content; selectively generate a distribution list based on the message data as related to the first user; distribute the message content instance to an access device connected by a wireless network of a member of the distribution list, the access device associate with a second user.

According to further features, the processors are further operable, when executing the instructions, to: increase the impression volume by a predefined number of units, when the message data includes a booster code.

According to another embodiment there is provided a method including: receiving, by a message center, a message from an access device connected to a wireless network and associated with a first user, the message including content data representative of a content instance compiled from a plurality of media objects into a single contiguous clip and a message data;

storing, by the message center, the message content; calculating an impression volume based on the message data; selectively generating a distribution list based on the message data as related to the first user; distributing, by the message center, the message content to a number of members of the distribution list corresponding to the impression volume; starting a countdown from a predefined amount of time allocated to the message content; and deleting the message content from the members when the countdown reaches zero, wherein the amount of time is configured to be increased when a predetermined reply code associated with the message content is received by the message center.

### BRIEF DESCRIPTION OF THE DRAWINGS

Various embodiments are herein described, by way of example only, with reference to the accompanying drawings, wherein:

FIGS. 1A-1C are simplified diagrams of message sender-recipient relationships;

FIG. 2 is an exemplary screenshot of a typical message displayed on the Graphical User Interface of the mobile application;

FIG. 3 is a screenshot of an exemplary page of the GUI of the mobile app for selecting features of the fame booster;

FIG. 3A is a second configuration of the endorsement feature;

FIGS. 4A and 4B are screenshots depicting the wheel slider;

FIGS. 5A and 5B are screenshots various features of the message viewer;

FIG. 6 is a screenshot 600 of an exemplary edit page of a user profile;

FIG. 7 is a screenshot of an exemplary page for composing a new message;

FIG. 8A is a screenshot of a Motion 800 created by the Motions feature;

FIG. 8B is a flow diagram of the Motion process;

FIG. 9 is an exemplary embodiment of the process for distributing a message on the real-time messaging platform;

FIG. 10 is a block diagram of an embodiment of a real-time messaging platform;

FIG. 11 are three screenshots displaying different message features.

### DESCRIPTION OF THE PREFERRED EMBODIMENTS

The principles and operation of a message-based online social network platform according to the present invention may be better understood with reference to the drawings and the accompanying description.

Content—Definition

In certain exemplary embodiments, one or more users of one or more access devices configured to communicate with a message center by way of a network are able to utilize the access devices to create content, select one or more filters (or no filter) for distributing the content, and provide the message, including the content and associated filter data (or lack thereof), to the message center. As used herein, the term “content” may refer to one or more “content instances,” which may include, but are not limited to, electronic data representative of text, one or more messages (e.g., short message service (“SMS”) messages or multimedia message service (“MMS”) messages), one or more symbols, one or more graphics, one or more images (e.g., digital photographs and video frames), video, audio, multimedia, or any segment, portion, component, or combination thereof.

Freemium—Free and Purchased Credits

‘Freemium’ is a broad term for a compensation model that includes both free services or features and for money services and features. In embodiments, the instant messaging platform employs a version of the Freemium model to pay for features. Some features of the system are free while other features cost ‘credits’. Credits are the native currency of the system. Users are given credits on a regular basis, e.g. once a day, once a week or once a month etc. Users pay for features that are not free with credits. If a user does not have enough credits in order to use a desired feature then the user can buy credits for real-world money.

The social network of the present invention is able to sustain itself without resorting to advertising, by using the aforementioned freemium compensation model. As a result, the instant messaging platform is free of advertising and participation from business entities. According to preferred embodiments, users who are not individuals but rather companies (or intend to use the user account to forward the objectives and goals of a business) are not permitted to become account holders. Likewise, users, who behavior is clearly business-related and a vehicle for advertising products and services of a business, are removed from network by the administrators.

Message Center—Definition

The message center may be configured to aggregate and store the content messages received from the access devices, and to selectively distribute the content based on the filter parameters indicated by the filter data as well as native algorithms that decide the volume (number of impressions) and actual distribution of the messages. For instance, when a user with an access device conforms to the parameters of the filter(s), e.g., a specified gender, of a filter associated with a content instance, the message center may make the content instance accessible to the user. The message center may send a notification of the content becoming accessible to the access device, and the user may utilize the access device to request and receive (e.g., download) the content instance from the message center.

The message center makes a decision to distribute the content instance to a given user access device, based on filter data as well as algorithm-run decisions. When the content instance is presented on a user interface, the appearance of the message content is considered ‘an impression’ and as such one unit is detracted from the decided impression volume count. Once the volume count has been exhausted, the message is no longer delivered to new access devices. The ‘life’ of a message, i.e. how long the message stays available (‘on the Wheel’) to the user is a variable that is decided by rule-based algorithms that may or may not be dynamically changed.

Messages Themselves

In this or similar manner, users of access devices may create and publish message content, and the content may be selectively distributed to users and/or access devices based on the parameters of the selected filters and/or decisions made by rule-based algorithms. Accordingly, users are able to control, to a certain degree, how content of a message is shared with other users by specifying filters, approving content and/or endorsing content.

The aggregation and distribution of messaged content (the word ‘messaged’ is the past tense conjugation of the verb ‘message’ as used in, for example, “I plan to message my friend this evening”; the use of the term as a verb or a noun can be understood from the context of the sentence) may enable users to connect with one another based on geographic locations by selecting the “My People” filter discussed below in further depth.

In certain embodiments, the message center may be configured to provide users associated with common content with one or more tools for annotating the content and/or communicating with one another. For example, a user who has been sent or granted access to message content may annotate the content such as by reposting the content, editing and reposting the content, rating the content, or posting a comment about the content to the message center. The user who posted the content may access the annotation and respond to the user who provided the annotation. Such communications between the users may be hosted as a communication thread to which the users involved may be granted access. Additional filter features will be discussed below.

The principles, operation and exemplary embodiments of distribution systems and methods of a content rich, message-based online social network platform according to the present invention may be better understood with reference to the drawings and the accompanying description.

P2P, My Network, Public

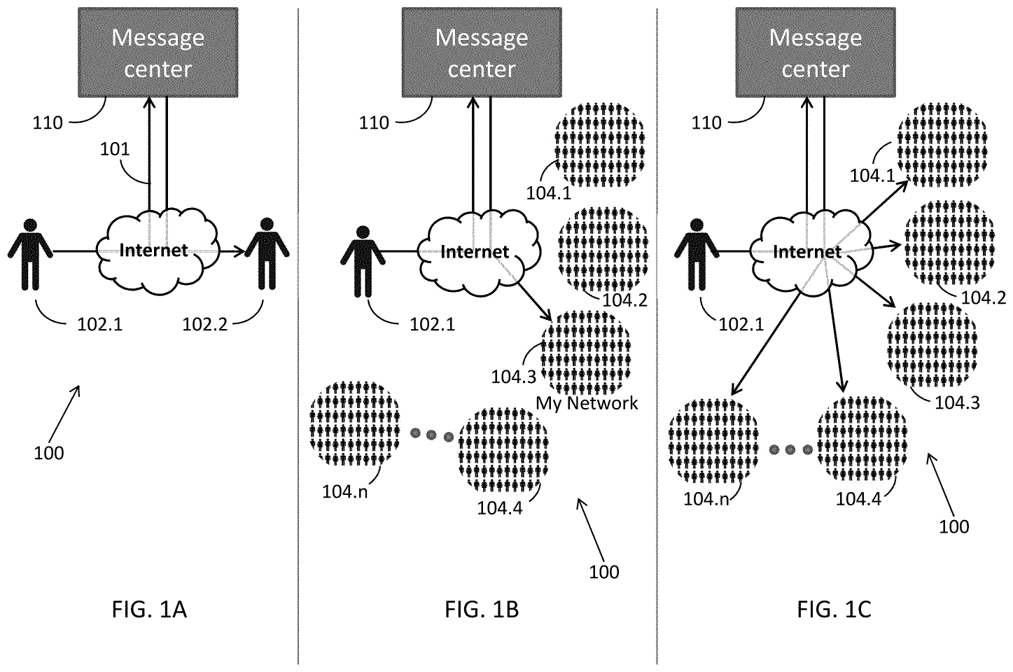

There are generally three distinct layers or levels of interactions between members of the social network. FIGS. 1A, 1B and 1C illustrate diagrammatic representations of the different levels/layers of interaction on the platform. On the most personal level there is an option to send a message to one person, a person-to-person (P2P) message. FIG. 1A is a simplified diagram of a person-to-person message that is sent from one user access device, to the message center and from there it is distributed to the selected recipient. The social network 100 consists of a message center 110, a first user access device 102.1 and a second user access device 102.2. The messages are delivered via a data communications network such as the Internet.

In order to send a message, the recipient must be a contact of the user. The term ‘contact’ refers to a member of the social network who is listed in the list of contacts of the user. In order to become a contact, the user adds personal details of the member as well as a phone number (preferably) into a contact list of the app or the native contact list of the mobile device, as is well known in the art. A contact can also be added from the web interface by entering the name and at least phone number of the member.

A second level of interactions is between the user and the people who are members of the personal network of the user, termed “My Network”, in the user interface. FIG. 1B is a simplified diagrammatic illustration of the interaction between a user and the personal sub-network of the user. A message is sent from user access device 102.1 to the message center 110 via the data communications network. The message is then distributed to the members of My Network 104.3. In embodiments, the message appears on the Wheel (in the main viewing area of the GUI) amongst other public and private messages.

‘My Network’ generally includes all the user's contacts who are members of the social network. In some embodiments, ‘Followers’(discussed in further details below) are also included in My Network. In other embodiments, Followers (also termed ‘Lookers’) are not included in My Network. FIG. 1B depicts the social network as a multiplicity of sub networks 104.1-104.n. While technically correct, the diagram is simplified to show each sub-network 104 as a separate entity while in reality the subnetworks are all interconnected with each other (users are members of more than one subnetwork). It can be said that the illustration is a collection of subnetworks as perceived from the users' point of view.

Within the subnetwork My Network, a user can define one or more groups which include selected members of the personal network. Groups can be defined to have certain characteristics, such as, for example, a ‘Public Group’ that can be seen by the public. Another example is a ‘Private Group’ that can also be seen by the public but the contents of the messages are hidden from non-members. A third example is a ‘Hidden Group’ where nobody can see the group and only members can view the contents of the messages. The first two levels of interactivity discussed above are considered ‘Private’ interactions.

The third level of interaction is between the user and the public. The public includes all the members of the social network. FIG. 1C is a simplified diagrammatic illustration of the interaction between a single user 102.1 and the entire social network 104.1-104.n. Any interaction with the social network at large is considered ‘Public’. Messages with no filters are distributed to the public. The public may include members of My Network.

A dynamic decision algorithm dictates how many impressions of the message are distributed to the network, to whom the messages are distributed, what percentage of impressions are distributed to members of My Network and what percentage is distributed to the public. Algorithms calculate the volume of impressions based on various factors of the user account. Exactly which factors and what weight various factors carry in the decision-making calculation are secret and may or may not be dynamic. One or more of the following factors contribute to the decision making calculation: age of account, activity on network, number of contacts, number of followers, number of followed members, age, location, gender, vocation, current number of credits, use of credits, number of liked messages, number of boosted messages, number of purchased credits and more.

Messages, Filters, Boosters

The present, innovative method, system and graphic user interface (GUI) is a message-based, online, social network platform. On the basic level, a user manufactures (create, copy, edit etc.) content and delivers the content in the form of a message which appears in the GUI of the access device of another user. As indicated above, a message can be personal (P2P), to a private forum or to a public forum. P2P messages go into a dedicated area names “Messages”. Private messages appear somewhere on the recipient's Wheel (main viewing area). Public messages may or may not reach another given user, depending on the distribution decisions of the message center algorithms. To improve, and provide a modicum of control over distribution of public messages, the innovative platform includes ‘Filters’ and ‘Boosters’. Boosters, according to some embodiments, can also improve the placement of private messages on the recipient's Wheel.

In broad strokes, Filters restrictively define a potential recipient pool whereas Boosters enlarge the actual recipient pool. Three types of innovative Filters are discussed below in further detail. One Booster is also discussed below in further detail. A Filter is a rule that defines what type of user the message is intended for. If a given user fulfils the criteria of the rule then that user is a potential recipient of the message. The number of recipients (message impressions) is finite and defined by system algorithms (as discussed above). Therefore, not every potential recipient that fulfils the criteria of the filter rule will receive the message using that filter. By contrast, a booster increases the number of actual users who will receive the message. For example, if the algorithm dictates that a given message will be distributed to 100 users, a booster can increase the number to 150 or 200 or whatever volume the administrators of the system decide. As such, filters and boosters can functions alone or in combination, i.e. a message may be filtered or boosted or both filtered and boosted.

User Interface

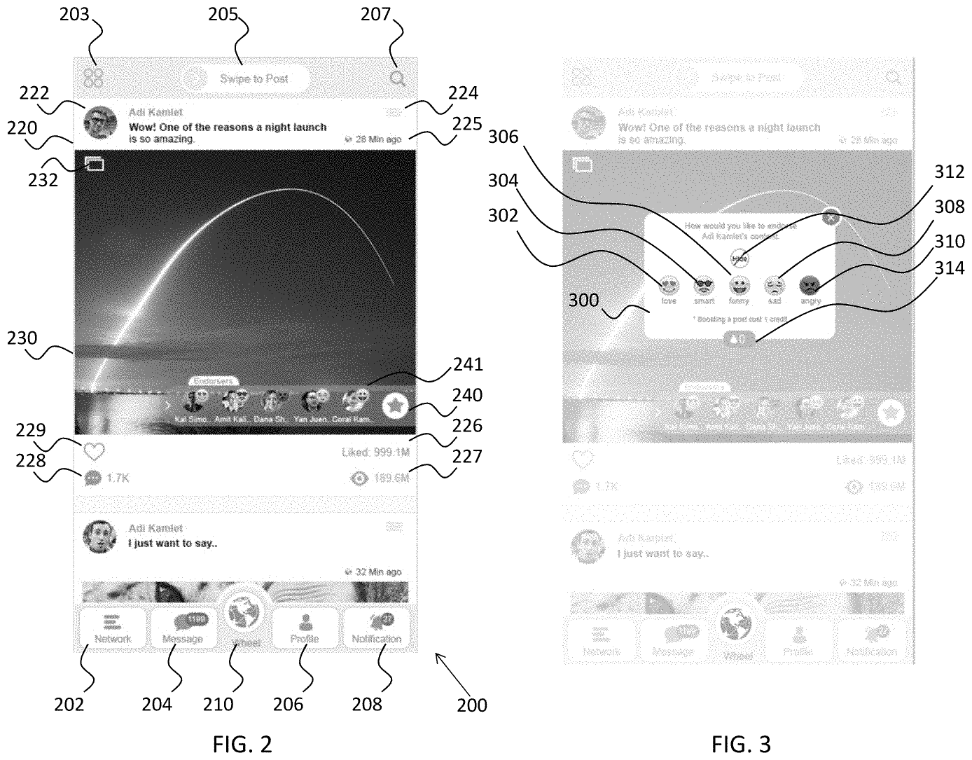

FIG. 2 illustrates an exemplary screenshot of a typical message displayed on the Graphical User Interface 200 of the mobile application. One message and part of a second message are visible in the screen shot. A menu bar of icon buttons is displayed at the bottom of the screen including a ‘Network’ button 202 on the extreme left-hand side and a ‘Message’ button 204 to the right of the Network button. A ‘Wheel’ button 210 depicting a globe is located in the center of the menu bar. Immediately to the right of the Wheel button is a ‘Profile’ button 206 and on the extreme right-hand side is a ‘Notification’ button 208. The functions and details of each of the buttons will be discussed below in further detail. Both the message icon-button and the notification icon button show notations of the numbers of messages and notification that are unopened.

At the top of the screen there is a menu icon 203 on left-hand side, a slider object 205 in the middle and a magnifying glass 207 on the right-hand side. The system menu 203 open a menu of functions related to the application. Actuating the slider 205 opens a new message for the user to compose. Clicking or tapping the magnifying glass 207 opens a search box.

Looking at the messages themselves, each message has a separate message box 220 and a message image 230. Various notations are superimposed over the periphery of the message image and of more details and/or values are posted around the borders of the message box. Each message is spaced apart from the following message. Moving clockwise from the top left-hand corner of the message box, the corner includes the name and icon 222 of the message sender with a brief text title. In the top-right corner is a menu icon 224 and immediately below that is the time counter 225 indicating how much time has passed since the message was received.

In the bottom right corner is a ‘Liked’ 226 value which reflects an approximate rating of the message based on the number of views and the number of users who indicated that they liked the message content. Beneath the Liked value is an ‘eye’ icon and counter 227 indicating the number of times the message has been viewed. The bottom left corner includes a reply icon (speech bubble with three dots) 228 indicating an approximated number of comments may on the message. Above the reply icon is a Heart button 229. The recipient is able to tap the Heart icon to indicate that they like the message content.

Fame Booster

The distribution of messages can be enhanced using the booster feature of the message platform. In general, a booster ensures that a message will be presented to other users a predefined number of times (‘booster volume’) more than the standard number of times the message is distributed. According to preferred embodiments, the number of ‘impressions’ that are guaranteed for the message is undisclosed. An impression is a single instance in which the message is presented in another user's Wheel viewing area (a portion of the graphic user interface dedicated to displaying message images 230). In embodiments, the booster volume simply refers to the number of impressions (even if shown to the same user more than one time) for the message. In other embodiments, booster volume refers to the number of impressions to unique users, i.e. the booster volume is equal to the number of unique users that will receive the boosted message.

According to an exemplary embodiment, the depicted GUI includes a special case of a booster, whereby, the booster is represented as a star icon 240 in the bottom right corner of the message image. The booster icon is also referred to as a Fame button, Fame booster, Endorsement button, and variations thereof. In preferred embodiments, selecting the endorsement button causes the messaging center to increase or boost the volume of impressions for the message. In embodiments, selecting the endorsement button improves the position of a non-public message (e.g. a message to some or all of the members of the My Network sub-network of the user). For example, an endorsed (boosted)message is positioned at the top of the recipient's Wheel, or within the first X number of messages displayed in the Wheel.

According to preferred embodiments, not only does the booster function to increase the number of impressions (e.g. by 50%, 100%, 200% or any amount for that matter) for the message, but the Fame booster further adds an emotional indication regarding the content of the message.

Selecting an arrow (not shown) next to the fame icon 240 slides out an endorsement banner 241 (which is shown extended with a reverse arrow for sliding the banner closed) which depicts a sample of users who have endorsed the message. The endorsements are further qualified and improved with an indicator of an emotion related to the content of the message. The endorsing user is represented by the user icon and the emotion is represented by the emoji character superimposed on the user icon. The recipient is able to endorse the message by actuating the star icon 240. The recipient is able to qualify the endorsement by selecting an emotion character ‘Emoji’ from a menu. Generally, the selected emoji is supposed to reflect the actual emotion (in general of course) of the recipient viewing and/or hearing the media content of the message.

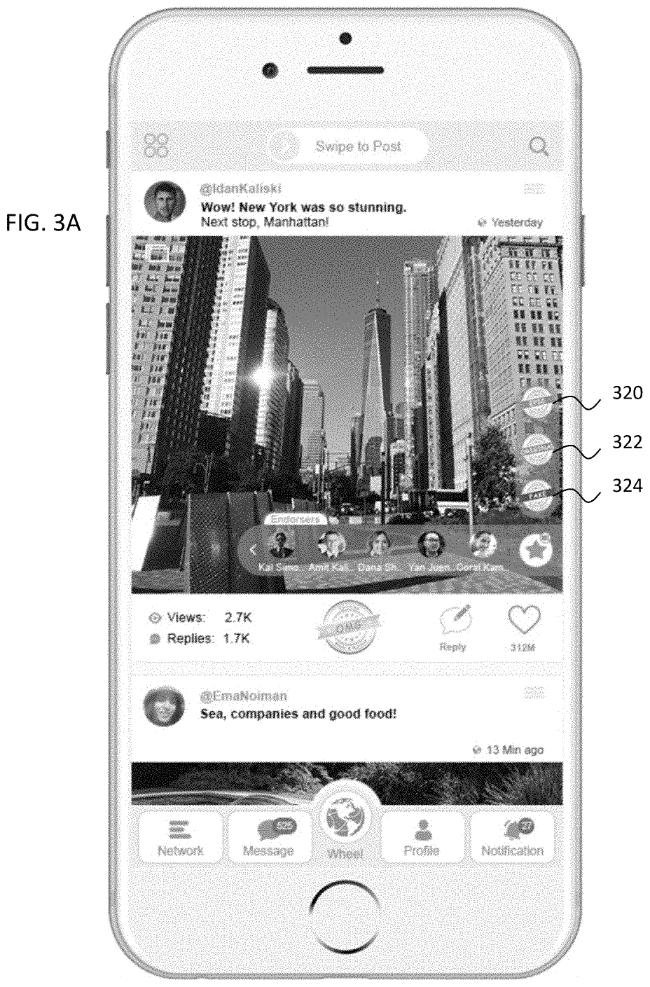

FIG. 3 is a screenshot of an exemplary page of the GUI of the mobile app for selecting features of the fame booster. In preferred embodiments, the booster is represented as a Fame icon, such as a star 240. When the fame icon is selected a pop-up menu 300 is overlaid the GUI which offers various options for characterizing the type of endorsement desired. The depicted emoji's and labels are merely exemplary and are in no way intended to me limiting. Any indicia (including audio, visual and audio-visual indicia) are included within the scope of the ‘emotional indicators’ of the present innovation. Referring to pop-up 300, starting from the left-most emoji and going from left to right, the emotional indicators are: a ‘love’ emoji icon 302, a ‘smart’ icon 304, a ‘funny’ icon 306, a ‘sad’ icon 308 and an angry icon 310. By characterizing the endorsement, recipients may be indicating a motivation for the endorsement of the message and/or give a hint as to the expected emotional reaction to the message content.

Another feature afforded by the present innovative platform is a secret endorsement of a message. A recipient who wishes to boost the message further into the public awareness but at the same time wishes to remain anonymous is able to select a ‘hide’ icon 312 from the pop-up menu. As mentioned above, the nature of the icon is merely exemplary, and not intended to be limiting in any way. The message gets increased fame and popularity from the boost, but the booster is not identified.

Due to the fact that the fame booster increases the popularity of a message, there is a need for a mechanism that will, de facto, limit the number of messages being boosted so as not to render the booster feature ineffective or obsolete. To curtail use of the booster feature, the platform charges a fee for boosting content. The fee is payable with in-app credits. As such, the pop-up menu also displays the current number of credits that the user owns. Exemplarily, a money bag icon 314 appears at the base of the pop-up menu together with the number of credits owned. Displaying the number of credits serves a number of functions, such as, for example, reminding the user that the boosting feature is not a free feature and allowing the user to gauge whether or not sufficient funds are available for all the desired for-fee activities. As discussed above, if the user does not have sufficient credits, the user can either wait the prescribed amount of time until being awarded more free credits or the user can purchase credits for real-world money.

FIG. 3A depicts a second configuration of the endorsement feature. According to the second configuration, members endorse the message and thereby increase the fame/popularity of the message. Furthermore, the endorsement includes various stamps. Exemplarily, the user can endorse with one of three stamps: an Epic stamp 320, an Original stamp 322 and a Fake stamp 324. The endorsement tool provide additional information and opinions to the message.

Wheel—Main Viewing Interface

The user interface for viewing messages/postings is known as the ‘Wheel’. Selecting the wheel icon 210 opens the Wheel viewer. The Wheel is the forum that displays both public and private messages, i.e. messages that are posted to the public and messages posted to the sender's sub-network (‘My Network’) of which the recipient is a contact member. The Wheel icon is exemplarily designated in the user interface as a globe of the world (as an allusion that the messages come from all over the world).

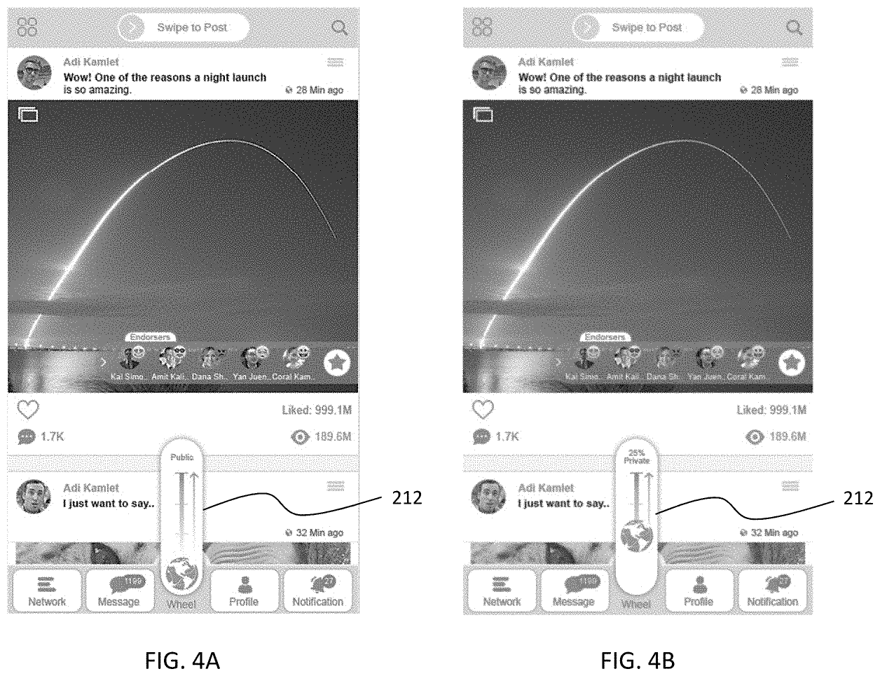

FIGS. 4A and 4B are screenshots depicting the wheel slider. In preferred embodiments, the Wheel exemplarily includes a slider-selector 212 which can be manipulated in order to select the desired mix of public and private (i.e. My Network-related) messages that are displayed on the Wheel forum/interface. Based on the placement of the wheel icon 210 on the slider 212, a processor of the user access device sends instructions to the message center 110 to adjust the ratio of public to private messages sent to the user access device. FIG. 4A shows the wheel at the bottom most position, exemplarily indicating that the messages received/viewed in the Wheel interface should come completely from public messages. FIG. 4B, shows the wheel at a slightly elevated position relative to that of FIG. 4A, exemplarily indicating that the messages received/viewed in the Wheel interface should include 25% of messages from private sources (i.e. messages being sent only to contacts and, in some embodiments, to followers).

To date, the distribution of messages from known (i.e. acquaintances/contacts) and unknown sources on social media has been controlled wholly by administrators of the network who devise (and manipulate) algorithms which make rule-based decisions regarding which messages or posts are seen by which users and which are not. The present innovative platform allows the user to select the ratio of public and private messages, thereby providing user input to administrator-created algorithms. As such, in the instant messaging platform, distribution of messages to recipients is based, at least in part, on selections of the recipients.

Message Viewer

Each message is an individual unit including media content (text, audio, still image, video), a dynamic rating value, a dynamic ‘viewed’ value and comments. Also, as discussed elsewhere, distribution data i.e. the number of impressions allotted to the message, can be dynamically affected both the sender and the recipients by employing boosters. Clicking, tapping or otherwise selecting a message from the wheel visual interface opens a new screen or page referred to herein as the Message Viewer which is the graphical template that displays the message content and related data.

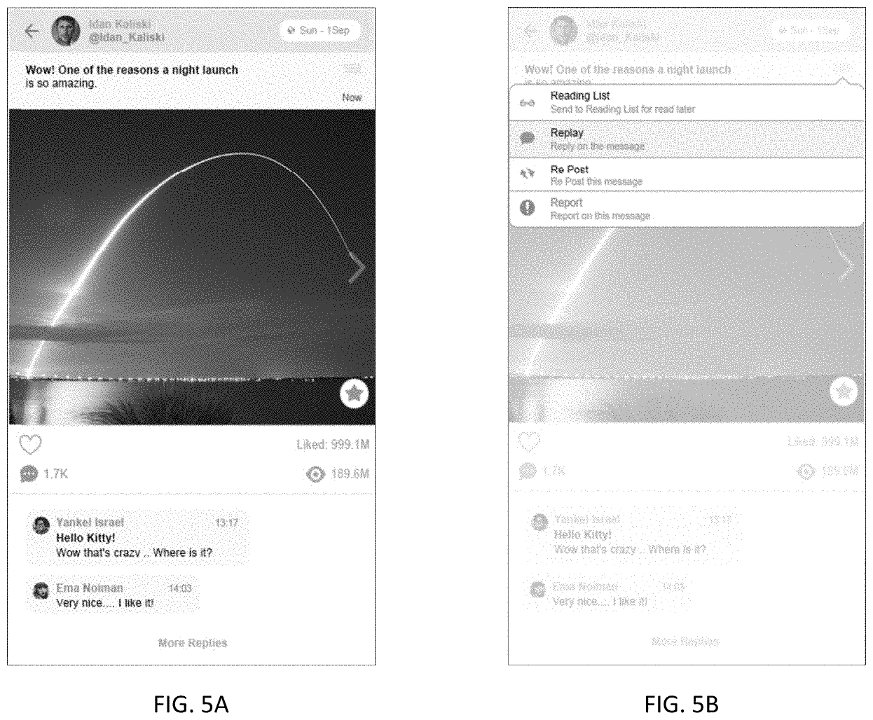

FIGS. 5A and 5B are screenshots various features of the message viewer. Exemplarily, the depicted embodiment in FIG. 5A of the message viewer depicts the message content in the central window (an image of a nighttime missile launch) with replies (member comments) below. FIG. 5B depicts a drop-down menu accessed by selecting the menu icon in the top right corner. Exemplarily, the menu includes the option to add the message content to a Reading List for viewing later (in the exemplary embodiment of the mobile app depicted in the screenshots, the Reading List is accessed by selecting the Notifications icon 208 in the menu bar). Further options in the menu include: adding a ‘Reply’ (note the typo in the menu) to the message content; Re-posting the message; and Reporting the message (e.g. as inappropriate). A reply can be in the form of a text reply, a recorded audio clip, an image or a video clip.

Reposting a message naturally increases the overall impressions of the message content. Furthermore, the popularity of the message content is noted by the system and added as a factor in the rule-based algorithms that calculate the volume and distribution of the message content. The popularity of a message may be based on one or more parameters selected from the group including: the number of endorsements, number of times reposted, number of comments (Replies) and the rating of the message content (e.g. number of times the heart icon was push relative to the number of times the message was viewed in total).

A reply is treated by the system in a similar fashion to a new message. The ‘reply content’ is sent to the message center together with a time stamp and message data which indicates which message the reply content is associated with. In one embodiment, the reply content is associated with the message content instance. In another embodiment, the reply content is associated with all instances of the message content. The distinction between the aforementioned embodiments is relevant with regards to reposted messages. According to the first embodiment, replies are native to a message received from a given member at a given time. Any reposting of the message by other members or by the original sender (at a later time) clears the history of replies and allows members to add new replies. According to the second embodiment, message content is identified by a unique identifier, regardless of the source of the message. Replies to the message are associated with the message via the unique identifier (exemplarily) and distributed to any member of the network that received the message, regardless of whether the message is the original message or a reposted message. Accordingly, in the first embodiment, the reply content is distributed to the same distribution list as that of the message content to which the reply is associated. According to the second embodiment, the reply content is stored at the message center and distributed to recipients of the original message as well as recipients of all future reposts of the same message. According to embodiments, replies have a predefined lifespan, and once the time of the predefined lifespan elapses, the message is deleted (from the message center servers, from the user access devices or both).

Profile

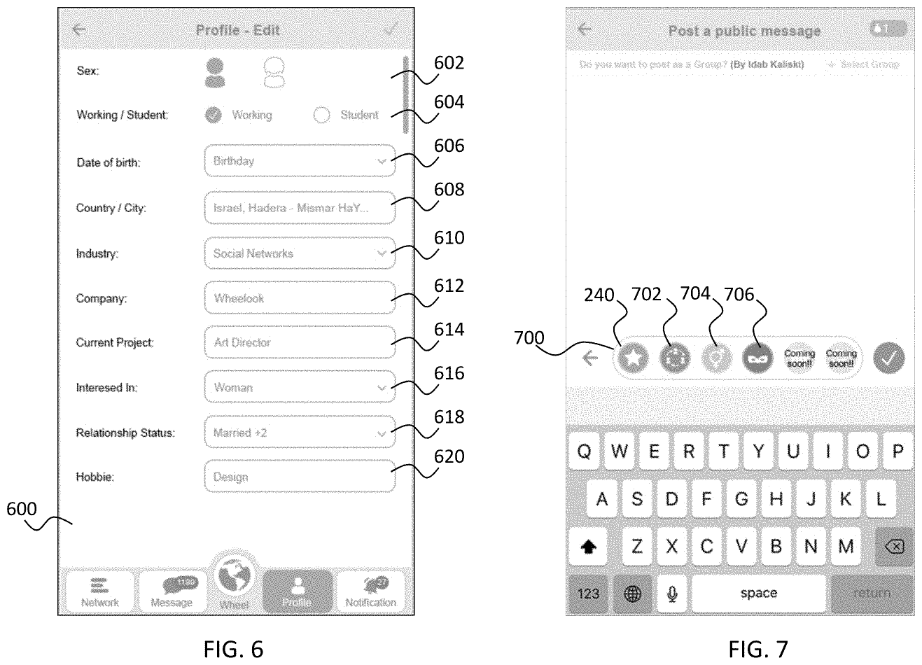

During registration on the messaging platform, the user provides details which form a user profile, or simply Profile. At any time, the user can view his or her profile as well as edit the profile. FIG. 6 is a screenshot 600 of an exemplary edit page of a user profile. Generally, only basic personal details are required when filling in the user profile. However, for the successful use of the platform (such as the various filters and booster features etc.), the more details added to the profile the better. Exemplarily, the Profile includes a gender selection 602, a working/learning status 604, a date of birth 606, a residence location 608, an industry 610, a company 612, a current project 614, interests 616, a relationship status 618 and hobbies 620.

In preferred embodiments, profile data is stored in databases or distributed databases of the message center. The message center may include one or more server computers including processors, memory, storage, software modules, etc. The servers may be collocated at a single site or remotely distributed and linked via a computer network, such as in a cloud-computing configuration.

My People Filter

Another innovative feature of the present platform is a specialized filter which is comprised of a number of rules. One goal or purpose of the presently disclosed feature is to target individuals who are similar to the sender of the message. To that end, the “My People” filter, in preferred embodiments, takes into consideration at least three parameters: location, industry and age. In other embodiments, the ‘industry’ parameter may be substituted and/or supplemented with a ‘hobby’ parameter or an ‘interest’ parameter and the like.

According to the aforementioned embodiment, the messaging process, using the exemplary ‘My People’ filter includes receiving, by the message center 110, a message from a first access device 102.1 connected to a wireless network (e.g. a cellular data network accessing a computing network such as the Internet) and associated with a first user, the message including data representative of a content instance and filter data including: a geographic location associated the first access device and/or the first user; an interest associated with the first user; and an age of the first user.

According to the process, the message content is stored on/by the message center. The stored content is then selectively distributed, by the message center, to at least one other access device (e.g. 102.2) connected to the wireless network. The decision to distribute the message content to at least a second user access device is based, in part, on the aforementioned geographic location corresponding to an approximate geographic location associated with a second user associated with the second access device. The geographic location may be the present geographic location of the second user (i.e. the access device associated with the second user), the geographic location of the work place of the second user and/or the geographic location of the address of the second user.

The present geographic location of the access device is determined by means known in the art, such as, but not limited to: GPS location, cell-tower triangulation, identification of the access device by a local wireless means (e.g. connection to a WiFi signal, connection via BlueTooth™ communication means to a geo-located device and the like), or any other manner known in the art. The geographic locations of the work places of the first and second users are documented on the user profiles respectively associated with each of the users. The same may apply for location of residence, depending on whether such information has been entered into the profile or not. Usually, at least a city of residence is listed in a profile. However, ascertaining a general location of a residence of a user, it is also known in the art (e.g. based on an IP address of a static user access device or wireless router, and/or a known location of a mobile user access device between midnight and sunrise on most days, etc.).

Exemplarily, the message center may run a word search of a given city name on a database on which user profiles are stored. In an alternative exemplary scenario, a virtual geographic boundary may be calculated by using the geographic coordinates of the location as a center point of the boundary and expanding the boundary by a predetermined (or dynamically determined) value.

According to embodiments, the distribution of the message content is further based on one or more of an interest, hobby and/or industry, being common to both the first user (sender) and at least the second user (recipient or recipients). In order to ascertain the aforementioned commonality, the processing unit of the message center receives or extracts the interest, hobby, industry, etc. from the profile of first user (sender). According to one embodiment, the message includes the type of interest, hobby and/or industry. According to another embodiment, the message includes a filter code which is indicative of an interest, hobby and/or industry. Subsequent to receiving the message which includes the filter data and content, the processing unit looks-up or extracts the interest, hobby and/or industry of the first user. Thereafter, the processing unit searches the database of profiles for matching or similar interests, hobbies and/or industries.

According to preferred embodiments, the distribution of the message content is further based on matching ages of the first and at least second user. Here too, the ages are both determined from the user profiles. Here too, the filter data may include the actual age of the sender or a filter code which the processing unit recognizes, according to instructions of machine-readable code stored on the storage device of the server computer(s) of the message center, as an indication to look-up or extract the age of the sender from the stored profile. Subsequently, the processing unit, following the aforementioned machine-readable computer instructions, conducts a search of user profiles for matching ages. In embodiments, the processing unit searches for ages within a predefined range above and/or below the age of the first user (e.g. 2 years above and 2 years below the given age).

It is known in the art to conduct database searches with more than one parameter. Any known method for searching the database of profiles to return a list of users that fulfil the aforementioned parameters is considered to be within the scope of the present disclosure. Furthermore, it is made clear that the ‘My People’ filter is merely an exemplary filter and similar filters, based on one or more parameter are included within the scope of the present disclosure. In embodiments where personal details stored in user profiles are different to those discussed herein, it is made clear that any facets of the user profiles, alone or in any combination, can be used as filter parameters in a similar fashion to that which is described herein.

In some embodiments, even the exemplary ‘My People’ filter may be configured such that results including two of the aforementioned parameters are also considered viable recipients of the filtered message. Once the list has been determined, rule-based algorithms determine the number of impressions (impression volume) of the message to be distributed to the filtered pool of potential recipients, as discussed above. Also, as discussed above, the impression volume may be boosted by the sender and/or by recipients of the message content.

In embodiments, one of the prerequisites is that the sender and recipient users are members of the same sub-network (e.g. appearing in the contact list of one or both of the users). In other embodiments, the first and second users being members of the same sub-network is not requisite to the distribution of the message content to the access device of the second user.

It is made clear that while the detailed descriptions of processing units, storage, databases, machine-readable instructions, server computers and the like are only detailed for some processes and not for others, the intent is that places where technical details have been elaborated are intended to apply equally or similarly mutatis mutandis to places where details have not been included, as if they have been included there as well. The lack of details is for the sake of brevity and clarity, not due to oversight.

FIG. 7 is a screenshot of an exemplary page for composing a new message. In the screen shot, a virtual keyboard is shown in the lower portion of the screen. The message ‘enhancements’ are depicted in a banner 700 in the middle of the screen. As part of the process of preparing a message, the sender can select a booster and/or one or more filters. The fame booster 240 icon button is exemplarily presented at the left-most position on the banner 700. A ‘My People’ Filter button 702 is to the immediate right of the booster icon. In embodiments, selecting the My People filter appends a predefined filter code to the filter data sent with the message content as part of the message sent to the message center. When received at the message center, the pre-defined filter is registered and the filter described above is applied to the message content.

Gender Filter

Another innovative feature of the present platform is a specialized filter which is comprised of a single, namely gender. The message content is bundled together with the filter data. The message center receives the message and notes the filter code (i.e. pertaining to gender) and the indicator which expressed which gender has been selected. The processing unit selects a number of gender correct users based on the algorithm-determined impression volume and whether the message was selected as a public or private message. If the message was indicated as public then the aforementioned selection is draws from the entire pool of users of the social network. If the message was indicated as a private (i.e. to the sub-network of the user only) then the recipients are selected from the sub-network, based on the selected gender, and limited to the algorithm-determined impression volume.

As with all other messages, it is possible for the sender and/or one or more of the recipients to boost the message impression volume by purchasing a booster (with free or purchased-for-real-world-money credits). A Gender Filter icon 704 is depicted in FIG. 7. As above, according to embodiments, selecting the gender filter adds an indicator to the message which indicates to the message center which filter is to be employed when distributing the instant mes sage.

Solo/Anonymous Filter

Another innovative feature of the present platform is a specialized filter which is comprised of one or more rules that are directed towards the goal of delivering the selected message to anyone except for known contacts of the user. The message is a public message by definition. The distinctive characteristic of the message is that any user that is a member of the sender's sub-network is filtered out of the potential pool of message recipients. Furthermore, in embodiments, users who ‘follow’ the sender (often referred to as ‘Followers’ or ‘Lookers’) are also excluded from the potential pool of message recipients. As such, any actual recipient of the message will not likely be acquainted with the sender, essentially rendering the message ‘anonymous’ (meaning that the sender is unknown to the recipient even though he or she is identified by name and icon).

As with all other messages, it is possible for the sender and/or one or more of the recipients to boost the message impression volume by purchasing a booster. An Anonymous Filter icon 706 is depicted in FIG. 7. As above, according to embodiments, selecting the anonymous filter adds an indicator to the message which indicates to the message center which filter is to be employed when distributing the instant message.

Followers/Lookers

Followers are members of the general social network by not a member of the target user's sub-network. In other words a member of the network who is not a member of a first user's contact list can still receive (potentially) public messages as well as notifications related to new content and posted/sent by the first recipient. In embodiments, a user can employ a feature to delete all Followers. Hereto, the innovative platform provides a modicum of control over the network members who receive messages and/or notifications when new messages are sent by users whom they ‘follow’.

In embodiments, with regards to the wheel selector discussed above, a follower has a third parameter with regards to the messages viewed in the Wheel interface, namely a ratio of messages from users/members they follow. As such, a follower of one of more network members can select to only receive public messages, or only private messages, or a selected ration between private and public messages or a mixed combination of public messages, private messages and messages from followed network members.

Motions

The presently innovative messaging platform includes an innovative feature referred to herein as ‘Motions’. Motions are computer-generated compilations of more than one media content. Messages in the platform include a single message content. The message content may be a single image, text, an audio clip or a video clip (visual or audio-visual). By contrast, Motions include at least two distinct media contents. The two (or more) contents may be two images, one image and one video clip, one video clip and an audio clip and an images and/or any combination thereof and of any multiplicity, within predefined limits.

Exemplarily, the message center receives the selected media items (message contents) and randomly forms the items into a coherent video clip. According to embodiments, the video clip may be enhanced or augmented by stock templates and/or graphic manipulations. For example, the video compilation may be displayed in a wide-screen format like a movie video. In another example, the compilation may be rendered into black in white.

The motion compilations can be posted in a similar fashion as described for messages. However, motions have a limited lifespan, after which time the motion is erased and no longer available for viewing. Innovatively, if a motion is ‘liked’/‘loved’ by a recipient/network member, then the lifespan of the motion is increased. Exemplarily, the platform includes a “Hall of Fame” listing the longest running motions. The more popular the motion is, the more opportunities there are for members to ‘like’ the motion.

As such, motions can be boosted or endorsed by the sender and/or recipients. However, boosting a motion does not increase the lifespan of the motion, it merely makes the motion available to more members of the network, thereby increasing the chances of the motion being liked. In embodiments, a motion can be reposted, which is referred to herein as a Remotion. Reposting a motion, as with boosting the motion, does not increase the lifespan of the motion. However, reposting a motion increases the popularity of the motion, as above. In other embodiments, motions cannot be reposted. In embodiments, members can add replies to motions. In other embodiments, members cannot add replies to motions.

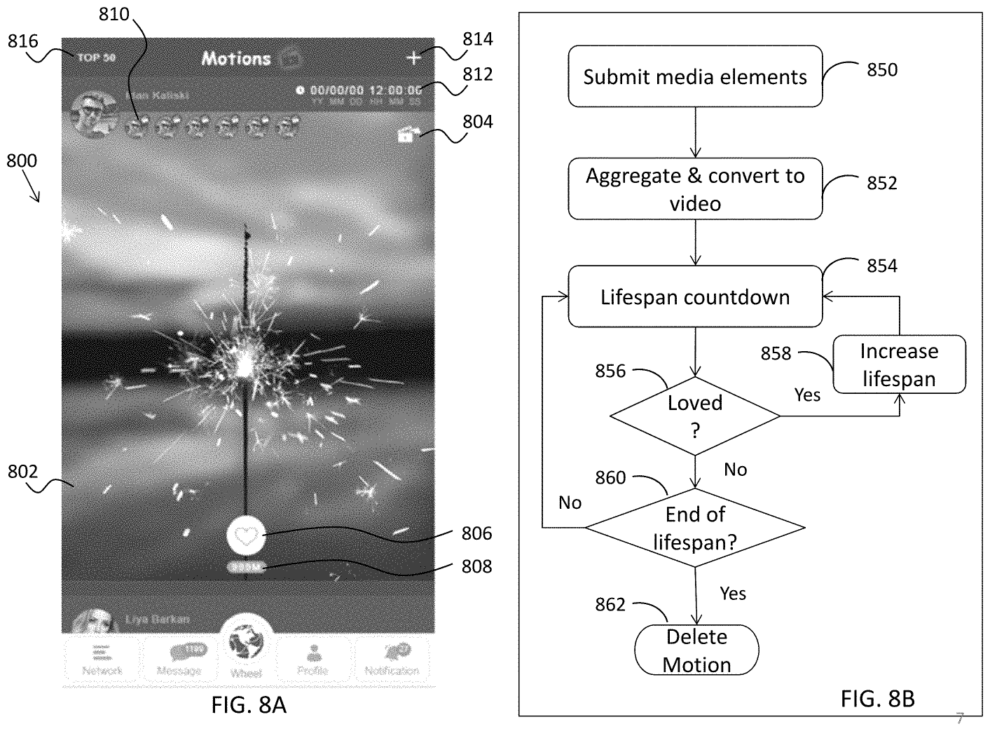

FIG. 8A is a screenshot of a Motion 800 created by the Motions feature. The main viewer includes a Motions image 802. Clicking on the motion image leads set the Motion compilation to run. In the top right-hand corner of the motion image is a Remotion icon 804 depicted as a clapperboard (clapper) with a curving arrow. According to the embodiment described above, clicking the Remotion icon 804 forwards initiates the process of forwarding the Motion to other recipients.

As described above, the remotion feature does not extend the lifespan of the motion. Remotioning merely expands the pool of recipients and the potential for Liking or Loving the Motion. To Love the motion, a recipient must click on the heart icon 806. The counter 808 gives an exact or approximate number of the Loves the motion has received. In the top left corner of the Motion image 800, under the sender icon, are seven Remotioned mini-icons 810. There is an icon for each user that remotioned the Motion. In the depicted case, the owner remotioned the Motion seven times.

In the top right hand corner, above the Motion image, a date and time counter 812 are depicted. In one configuration, the date and time indication when the Motion was first created/sent. In another configuration, the date and time indicate when the Motion will be deleted (i.e. a countdown counter). In still another configuration, the date indicates when the Motion was created and the time is a countdown counter indicating how much longer the Motion has before being deleted by the system (i.e. lifespan). Above the date and time is a plus sign 814 which is the clickable button for creating a new Motion 800. In the top left corner is a ‘Top 50’ clickable button 816 which opens the Hall of Fame of Motions described above.

FIG. 8B is a flow diagram of the Motion process. At step 850 the composer submits the media files to the system for aggregation, compilation and conversion, which occurs at step 852. Once compiled and sent, the lifespan counter begins a countdown at step 854. The lifespan of a motion is predefined by the system administrators. If one of the recipients of the Motion clicks on the Love icon 806, at step 856, then the lifespan of the motion is increased at step 858. The Administrators of the system define by how long the lifespan of the Motion is increased for each time the Motion is Loved.

At step 860 the system monitors whether the lifespan of the motion has been expended. If not, the process goes back to step 854. If the lifespan is expended, then at step 862 the motion is deleted. Deleting a motion mean that it is deleted from the system and no longer viewable by the recipients unless downloaded/copied to a local storage device.

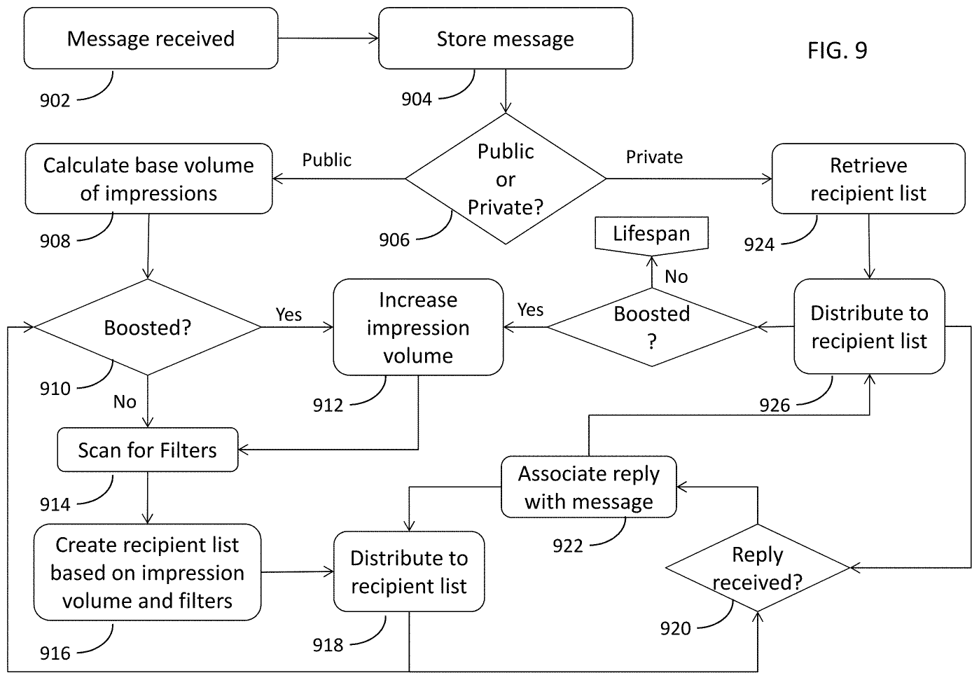

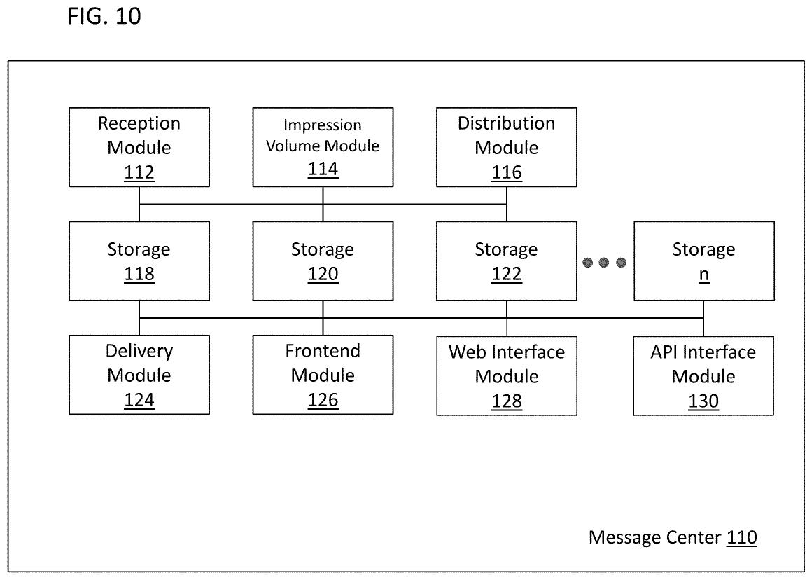

The system described below with regards to FIG. 10 (and mutatis mutandis to the flow chart of FIG. 9), is employed in a similar fashion to the Motion process described heretofore.

System Overview

FIG. 10 is a diagram of an embodiment of a real-time messaging platform 110, referred to herein as message center 110. Only components that are germane to the invention are discussed herein. It is made clear that all the legacy hardware, firmware and software known in the art that is necessary for the smooth running of the message center are considered to be incorporated as if fully set forth herein. The real-time messaging platform 110 includes a reception module 112, an impression volume module 114, a distribution module 116, various storage modules 118, 120, 122, a delivery module 124 and a frontend module 126.

A user of the platform composes a message 101 to be sent from a user access device. The user access device can be any computing device, for example, a mobile phone, a personal computer (laptop, desktop, or server), or a specialized appliance having communication capability. The access device can utilize any of a number of advantageous interfaces, including a web-based client, a Short Messaging Service (SMS) interface, an instant messaging interface, an email-based interface, an API function-based interface, etc. Preferably, the interface is a GUI of a dedicated mobile app having the same or similar features to those described heretofore. The message 101 can be transmitted through a communication network to the real-time messaging platform 110.

FIG. 9 depicts an exemplary embodiment of the process for distributing a message on the real-time messaging platform 110. The reception module 112 in the real-time messaging platform 110 receives the message 101 at step 902. The message includes message content and message data. Reception module 112 proceeds to store the message 101 in a message storage module 118 at step 904. The message 101 is assigned an identifier. In some embodiments, the message content is assigned a unique identifier, different to the identifier assigned to the message.

The sender of the message and the filter data and/or the booster data included in the message is passed to the impression volume module 114. The impression volume module 114 is responsible for calculating the number of impressions of the message to be distributed on the network. Impression volume module 114 includes the algorithms discussed above for calculating the volume of impressions for each message. The impression volume module 114 first registers whether the message is a Private or Public message at step 906. If the message is a private message, message is passed to the distribution module 116. If the message is a public message, the impression volume module assesses analyzes the sender data using the aforementioned algorithms in order to ascertain a base volume of impressions at step 908.

At step 910 the impression volume module 114 searches for an indicator in order to know whether a booster indicator is associated with the message. If a booster code is detected at step 910 then impression volume module deducts the predefined number of credits from the user credit score (not shown). If there are insufficient funds, a message is sent to the user access device with the relevant notification. Various alternative processes are known in the art for ensuring for-fee services are only provided if the requisite fee is paid. Those processes are incorporated as if fully set forth herein. If the feature is allowed (i.e. there are sufficient credits or if credits are purchased with real-world currency), the volume of the impressions is increased by a pre-defined or dynamically defined number or percentage of impressions at step 912. If no boosters are found, or once the booster-related impressions have been added to the impression volume the impression volume is passed to the Distribution module 116.

Distribution module 116 scans the message for filters, at step 914. At step 916 the Distribution module creates a recipient list of members of the network that will receive the message content, based on the filters and the calculated impression volume. The Distribution module sends the recipient list to the Delivery module 124. At step 918, the delivery module 124 takes the recipient list of accounts from the distribution module 116 and the message identifier (and/or unique message content identifier) generated by the reception module 112 and proceeds to insert the message identifier into message list data associated with each identified account and stored in the message list storage module 120.

The reply sub-process includes step 920 where the frontend module 126 receives reply data. The reply data includes content and a message identifier. At step 922, Frontend module 126 associates the reply content with the message identifier according to a timeline (not shown). The reply content is then passed to the delivery module 124 to be distributed to the recipient list of the message identified by the message identifier.

Frontend module 126 is also responsible for receiving a booster indicator from one of the recipients in the recipient list. In some embodiments, a booster indicator can be included in the reply data discussed above. When a booster indicator is received the process goes back to step 912 and continues from there as discussed above.

If the message is a Private message, i.e. to some or all of the members of the user's sub-network, then the distribution module 116 is responsible for retrieving sub-network data from the user-data storage module 122, at step 924, and using the user sub-network data to determine which accounts (i.e. users) in the real-time messaging platform 110 should receive the message 101. The user sub-network data, for example, can also reflect which accounts in the real-time messaging platform are “following”/“looking” a particular account and are, therefore, subscribed to receive messages from the particular account. The user sub-network data can reflect more sophisticated relationships between the accounts.

At step 926 the delivery module 124 takes the list of accounts from the distribution module 116 and the message identifier generated by the reception module 112 and proceeds to insert the message identifier into message list data associated with each identified account and stored in the message list storage module 120. The message lists stored in the timeline storage module 120 can be a “timeline” of messages associated with the account or can reflect any arbitrary organization of the messages that is advantageous for the user of the account on the real-time messaging platform 110.

If a reply is received, the sub-process 920, 922 described above is employed. If the message is boosted, then the processes for boosting a message is employed as described above for steps 912 and on. In some embodiments, private messages are delivered to all recipients, thereby obviating at least one element of the boosting feature (i.e. increase impression volume). According to other embodiments, even private messages can be boosted with all the functionality of the booster (endorsement, emotion and impression volume). In embodiments, when there is no activity associated with a message, for a predetermined time (“lifespan”), then the message is erased from the wheel.

The delivery module 124 uses the storage modules 118, 120, 122 to construct message lists for serving to a user of the account on the real-time messaging platform 110. As with the sender, a recipient can use any access device to receive the messages. The access device of the recipient can also be any computing device providing any of a number of advantageous interfaces. For example, where the user uses a web-based client to access their messages, a web interface module 128 can be used to construct the message lists and serve the lists to the user. Where the user uses a client that accesses the real-time messaging platform 110 through an API, an API interface module 130 can be utilized to construct the message lists and serve the lists to the client for presentation to the user

Each module illustrated in FIG. 10 can be implemented using software executing on generic processing hardware, comprising a processor and memory. Each module can represent a separate process or thread or other execution context running on the same or different machines. Similarly, and without limitation, the modules can be represented through equivalent electrical circuits, microcode, or other implementations of the described functionality.

Embodied On Web Interface

An exemplary content module can be embedded in an electronic document such as a webpage of a website. The electronic document can be embodied as any form of Internet content, e.g., as pages of HTML markup or XML markup or as executable Java or Javascript, etc. The content module can be a separate executable program (such as a plugin) or can be an integrated script, such as Javascript integrated with the rest of the electronic document. The content module communicates with the real-time messaging platform 110, for example by communicating with the API interface module 130. The content module provides an identifier, for example, the URL associated with the electronic document. The real-time messaging platform 110, using the above-disclosed technique, provides suggested accounts and/or suggested messages associated with the content of the electronic document through the API.

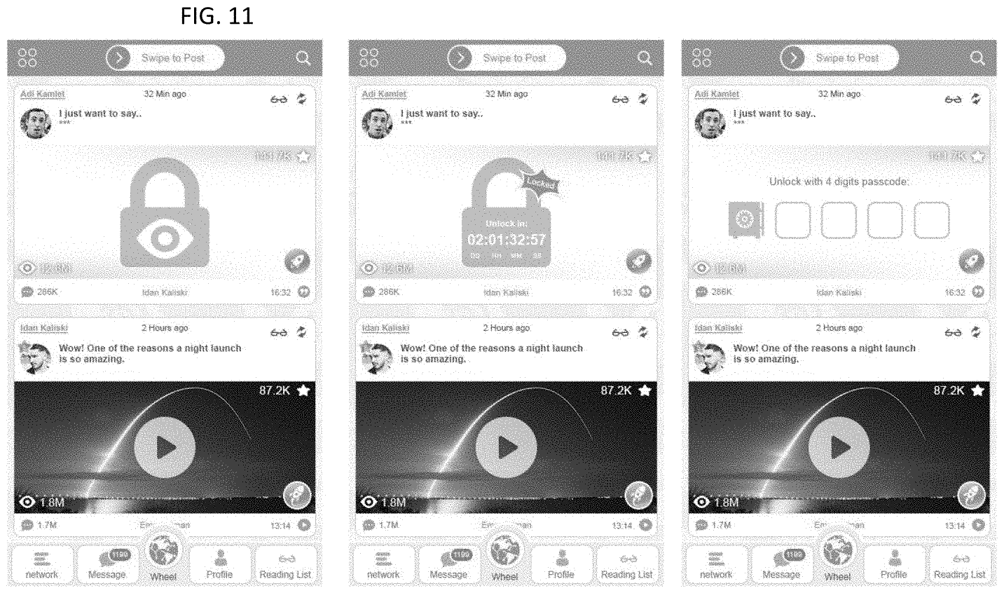

FIG. 11 depicts three screenshots displaying different message features, on the top messages, according to another configuration of the innovative real-time messaging platform. The leftmost screenshot (top message) depicts a padlock with an eye icon on the padlock. The eye-padlock 1110 indicates that the message can only be viewed under certain circumstances. In preferred embodiments, the eye-padlock 1110 indicates that the message can only be viewed once.

The middle screen shot (top message) depicts a padlock with a counter 1120. This is an Easter-egg type message. The counter indicates the amount of time in which the message will become available. This message is essentially a time-delayed message. Such a feature creates suspense around the secret content of the message as well as allowing the sender to post a message in advance. Such a message feature can be useful for posting an as-of-yet unrevealed trailer of an upcoming movie or an announcement such as an surprise engagement which is unlocked after the planned surprise—letting friends and family know immediately after the fact, without having to ruin the occasion by phoning around and letting people know.

The right-most message (top message) is a passcode-locked message 1130. The message is therefore only available to members who have the unlock code. Such a message feature is very useful for posting secure information. Another envisioned exemplary scenario is a treasure hunt where finding one clue gives the code to receive the next clue by unlocking the message. Many other scenarios are envisioned. The features described heretofore are examples of ways in which the innovative messaging platform gives users a certain degree of control over messages that are privately and even publicly posted.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A method comprising:
receiving, by a message center, a message from an access device connected to a wireless network and associated with a first user, the message including content data representative of a content instance and a message data;
storing, by the message center, said message content;
calculating an impression volume based on said message data;
selectively generating a distribution list based on said message data as related to said first user;
distributing, by said message center, said message content to a number of members of said distribution list corresponding to said impression volume.

2. The method of claim 1, wherein said message data includes a booster code, said booster code increasing said impression volume by a predefined number of units.

3. The method of claim 1, wherein said message data includes a filter, said filter providing rules for selecting said distribution list from members of said message center.

4. The method of claim 3, wherein said filter indicates at least a portion of a sub network associated with said first user.

5. The method of claim 3, wherein said filter indicates one gender.

6. The method of claim 3, wherein said filter includes rules pertaining to a geographic location associate with said first user.

7. The method of claim 3, wherein said filter includes rules extracted from a profile of said first user.

8. The method of claim 1, wherein said message content is received by a second user and wherein said second user sends a booster code to said message center, resulting in said message center increasing said impression volume and distributing said message contents to corresponding number of additional members of said message center.

9. The method of claim 8, wherein said booster code includes data indicative of a graphical representation of an emotion, said graphical representation being displayed in association with said message content.

10. A system comprising:
one or more processors;
and a memory coupled to said processors comprising instructions executable by said processors, said processors being operable when executing said instructions to:
store data representative of a message content, said message content being associated with a first user;
calculate an impression volume based on message data associated with said message content;
selectively generate a distribution list based on said message data as related to said first user;
distribute said message content instance to an access device connected by a wireless network of a member of said distribution list, said access device associate with a second user.

11. The system of claim 10, wherein said processors are further operable, when executing said instructions, to:
increase said impression volume by a predefined number of units, when said message data includes a booster code.

12. A method comprising:
receiving, by a message center, a message from an access device connected to a wireless network and associated with a first user, the message including content data representative of a content instance compiled from a plurality of media objects into a single contiguous clip and a message data;
storing, by the message center, said message content;
calculating an impression volume based on said message data;
selectively generating a distribution list based on said message data as related to said first user;
distributing, by said message center, said message content to a number of members of said distribution list corresponding to said impression volume;
starting a countdown from a predefined amount of time allocated to said message content; and
deleting said message content from said members when said countdown reaches zero, wherein said amount of time is configured to be increased when a predetermined reply code associated with said message content is received by said message center.
